(19) United States
(12) Patent Application Publication
(10) Pub. No.: US 2022/0044110 A1
(43) Pub. Date: Feb. 10, 2022

(54) CONTROLLING AGENTS USING REINFORCEMENT LEARNING WITH MIXED-INTEGER PROGRAMMING

(71) Applicant: Google LLC, Mountain View, CA (US)

(72) Inventors: Mungyung Ryu, Sunnyvale, CA (US); Yinlam Chow, San Carlos, CA (US); Ross Michael Anderson, Somerville, MA (US); Christian Tjandraatmadja, Cambridge, MA (US); Craig Edgar Boutilier, Palo Alto, CA (US)

(21) Appl. No.: 16/987,246

(22) Filed: Aug. 6, 2020

(51) Int. Cl. G06N 3/08; G06N 3/04

(52) U.S. Cl. CPC G06N 3/08; G06N 3/0454

(57) ABSTRACT

Methods, systems, and apparatus, including computer programs encoded on computer storage media, for training a neural network system used to control an agent interacting with an environment. One of the methods includes obtaining a plurality of transitions that are each generated as a result of an agent interacting with an environment, and training a Q neural network having a mixed-integer programming (MIP) formulation on the transitions. The Q neural network is configured to process an observation and initial action constraints in accordance with the Q network parameters to generate a MIP problem based on a Q value objective and the initial action constraints. The initial action constraints specify a set of possible actions that can be performed by the agent to interact with the environment.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a reinforcement learning system that controls an agent interacting with an environment.

Particular embodiments of the subject matter described in this specification can be implemented so as to realize one or more of the following advantages.

Many complex tasks, e.g., robotic tasks, require selecting an action from a large discrete action space, a continuous action space, or a hybrid action space, i.e., with some sub-actions being discrete and others being continuous. In order to apply a traditional Q-learning technique to such tasks or to select an action using a conventional Q neural network, a maximization over the set of possible actions (or a discretized version of the set of actions) needs to be repeatedly performed. In particular, when the action space is large or continuous, this maximization can be difficult to achieve through existing techniques including gradient ascent and cross-entropy search. A conventional reinforcement learning system may end up being trained to control the agent using suboptimal action selection policies in which an “argmax” action (i.e., the action with the highest Q value) is not always guaranteed to be selected at each state of the environment being interacted with by the agent.

In contrast, the system described in this specification makes use of a Q neural network that has been formulated as mixed integer programming (MIP). Under this formulation, the Q neural network can process a Q network input including an observation of the environment and initial action constraints to generate a set of output values which specify a Q value objective that is to be optimized subject to a set of action constraints. By repeatedly evaluating the MIP problems defined by using the Q neural network, the system can robustly determine an argmax action each time that an action needs to be selected for performance by the agent and each time that an update to the Q network parameters is determined. Thus, the system can control the agent for different tasks in a way that expected long-term return received by the agent is maximized, even when the tasks require a large discrete action space, a continuous action space, or a hybrid action space.

Additionally, the system described in this specification also includes an actor neural network that is configured to implement a respective mapping from each observation to a corresponding argmax action that would be determined by evaluating the MIP problem defined by using the Q neural network. This allows the system select actions to be performed by the agent with reduced amount of computational resources because the computationally intensive MIP evaluation steps are no longer required. In other words, the system can also control the agent with reduced latency and reduced consumption of computational resources while still maintaining effective performance.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for training a Q neural network.

FIG. 3 is a flow diagram of an example process for training an actor neural network.

FIG. 4 is a flow diagram of an example process for controlling an agent using an actor neural network.

FIG. 5 is a flow diagram of an example process for controlling an agent using a Q neural network.

Like reference numbers and designations in the various drawings indicate like elements.

### DETAILED DESCRIPTION

This specification describes a reinforcement learning system that controls an agent interacting with an environment by, at each of multiple time steps, processing data characterizing the current state of the environment at the time step (i.e., an “observation”) to select an action to be performed by the agent.

At each time step, the state of the environment at the time step depends on the state of the environment at the previous time step and the action performed by the agent at the previous time step.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., one or more of: images, object position data, and sensor data to capture observations as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control inputs to control the robot, e.g., torques for the joints of the robot or higher-level control commands, or the autonomous or semi-autonomous land, air, sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g., braking and/or acceleration of the vehicle.

In some other applications the agent may control actions in a real-world environment including items of equipment, for example in a data center, in a power/water distribution system, or in a manufacturing plant or service facility. The observations may then relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility.

In the case of an electronic agent the observations may include data from one or more sensors monitoring part of a plant or service facility such as current, voltage, power, temperature and other sensors and/or electronic signals representing the functioning of electronic and/or mechanical items of equipment. For example the real-world environment may be a manufacturing plant or service facility, the observations may relate to operation of the plant or facility, for example to resource usage such as power consumption, and the agent may control actions or operations in the plant/facility, for example to reduce resource usage. In some other implementations the real-world environment may be a renewal energy plant, the observations may relate to operation of the plant, for example to maximize present or future planned electrical power generation, and the agent may control actions or operations in the plant to achieve this.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In some implementations the environment may be a simulated environment and the agent may be implemented as one or more computers interacting with the simulated environment.

The simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

In some implementations, the simulated environment may be a simulation of a particular real-world environment. For example, the system may be used to select actions in the simulated environment during training or evaluation of the control neural network and, after training or evaluation or both are complete, may be deployed for controlling a real-world agent in the real-world environment that is simulated by the simulated environment. This can avoid unnecessary wear and tear on and damage to the real-world environment or real-world agent and can allow the control neural network to be trained and evaluated on situations that occur rarely or are difficult to re-create in the real-world environment.

Generally, in the case of a simulated environment, the observations may include simulated versions of one or more of the previously described observations or types of observations and the actions may include simulated versions of one or more of the previously described actions or types of actions.

Optionally, in any of the above implementations, the observation at any given time step may include data from a previous time step that may be beneficial in characterizing the environment, e.g., the action performed at the previous time step, the reward received at the previous time step, and so on.

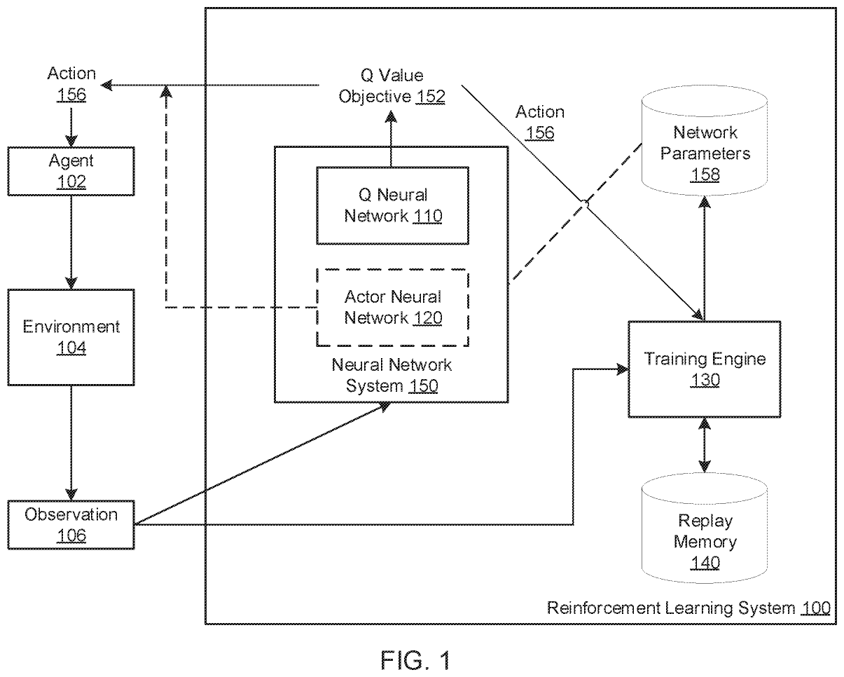

FIG. 1 shows an example reinforcement learning system 100. The reinforcement learning system 100 is an example of a system implemented as computer programs on one or more computers in one or more locations in which the systems, components, and techniques described below are implemented.

The system 100 controls an agent 102 interacting with an environment 104 by selecting actions 156 to be performed by the agent 102 and then causing the agent 102 to perform the selected actions 156.

Performance of the selected actions 156 by the agent 102 generally causes the environment 104 to transition into new states. By repeatedly causing the agent 102 to act in the environment 104, the system 100 can control the agent 102 to complete a specified task.

The system 100 uses Q values to control the agent, for example, by selecting an action with the highest Q value at each state of the environment. The Q value for an action is an estimate of a “return” that would result from the agent performing the action in response to the current observation 106 and thereafter selecting future actions performed by the agent 102 in accordance with the current values of the network parameters.

A return refers to a cumulative measure of “rewards” received by the agent 102, for example, a time-discounted sum of rewards. The agent 102 can receive a respective reward at each time step, where the reward is specified by a scalar numerical value and characterizes, e.g., a progress of the agent towards completing a specified task.

Conventionally, to select the action 156 with the highest Q value, the system 100 would have to process each action in a set of possible actions that can be performed by the agent 102 using a neural network (that is trained to approximate a Q-value function) in order to generate Q values for all of the actions in the set of possible actions. When the action space is continuous, i.e., all of the action values in an individual action are selected from a continuous range of possible values, or hybrid, i.e., one or more of the action values in an individual action are selected from a continuous range of possible values, this is not feasible, as it is not computationally efficient and consumes a large amount of computational resources to select a single action. An example of such a continuous value is a position, velocity or acceleration/torque applied to a robot joint or vehicle part. Alternative techniques such as gradient ascent and cross-entropy search, which aim at reducing the number of actions that need to be evaluated by using the neural network, are also problematic because these methods may fail to accurately identify the optimal action, i.e., the action with the highest Q value, among a continuous action space. That is, these alternative techniques may result in the action that is not the action with the highest Q value being identified.

The system 100 instead selects the action to be performed by the agent by using mixed integer programming (MIP) optimization techniques, which are generally more robust and are capable of finding the optimal actions that ultimately improve a performance measure of the agent on the specified task.

In particular, the system 100 includes a neural network system 150, a training engine 130, and one or more memories storing a set of network parameters 158 of the neural networks that are included in the neural network system 150. The neural network system 150, in turn, includes a Q neural network 110 and an actor neural network 120.

At a high level, the Q neural network 110 is a neural network having a plurality of parameters (referred to as “Q network parameters”) with a mixed integer programming (MIP) formulation. The specifics of the MIP formulation of a neural network are described in more detail in Anderson, et al, Strong mixed-integer programming formulations for trained neural networks, arXiv preprint, arXiv:1811.01988, 2019, and Fischetti, et al, Deep neural networks and mixed integer linear optimization, Constraints, 2018, the entire contents of which are hereby incorporated by reference herein in their entirety.

For convenience, this specification largely describes the Q neural network 110 as a fully-connected feed-forward network with rectified linear unit (ReLU) activation. It should be noted that, however, the described techniques can be similarly applied to neural networks having different architectures, e.g., networks that include convolutional layers, max-pooling layers, or both in place of or in addition to the fully-connected layers. These network layers can also have different activation functions that are piecewise linear, e.g., piecewise linear unit (PLU) or leaky ReLU activations.

In response to any given observation, the system 100 can use the Q neural network 110 to generate a mixed integer programming (MIP) problem based on a Q value objective 152. The system 100 can then identify the action to be performed by the agent by solving the MIP problem for optimizing the Q value objective subject to a set of action constraints. The Q value objective 152 specifies a Q variable for which a value is to be optimized (i.e., maximized) as part of solving the MIP problem through suitable optimization techniques. The action constraints represent one or more limitations imposed by any of a variety of possible circumstances that serve to constrain the variety of feasible solutions that may be derived as part of deriving the optimal value for the specified Q variable, as set forth by the Q value objective. For example, such limitations may be imposed by the environment, the agent itself, or another agent in the environment. For example, if the agent is a robot then the action constraints may include limitations on feasible angles of certain joints due a current robot pose. As another example, if the agent is a vehicle then the action constraint may include limitations on feasible vehicle headings due to obstacles ahead of the vehicle.

In mathematical terms, the system 100 processes a Q network input including (i) a current observation 106 which characterizes the given state of the environment and (ii) initial action constraint which specify a set of possible actions that can be performed by the agent to interact with the environment using the Q neural network 110 that includes K layers each having m units to formulate the following MIP problem:

$${q}_{x}^{*} = max {c}^{T} {z}_{k}$$

$$s . t . {z}_{1} \text{:=} a ∈ {B}_{∞} ( \overline{a} , Δ ) , \\ ( {z}_{j - 1} , {z}_{j , i} , {ζ}_{j , i} ) ∈ R ( {W}_{j , i} , {b}_{j , i} , {ℓ}_{j - 1} , {u}_{j - 1} ) , \\ j ∈ \{ 2 , … , K \} , i ∈ \{ 1 , … , {m}_{j} \} , \\ where$$

$$R ( w , b , ℓ , u ) = \{ ( x , z , ζ ) \vert \begin{matrix}z \geq {w}^{T} x + b , z \geq 0 , z \leq {w}^{T} x + b - {M}^{- 1} ( 1 - ζ ) , z \leq {M}^{+} ζ , \\ ( x , z , ζ ) ∈ [ ℓ , u ] \times \times \{ 0 , 1 \}\end{matrix} \} .$$

In particular, the set of possible actions are continuous actions. An action is continuous when the possible value for the action is selected from a continuous range of action values, i.e., all of the action values in an individual action are selected from a continuous range of possible values, or hybrid, i.e., one or more of the action values in an individual action are selected from a continuous range of possible values.

In the equations above, M⁺=max [symbol] w^{T}x+b and denotes the biggest possible values outputted from the ReLU (i.e., the rectified linear unit activation function considered by R), M⁻=min [symbol] w^{T}x+b and denotes smallest possible values outputted from the ReLU, x denotes the input variables to the ReLU, z₁ is the Q network input, zⱼ denotes the output variables at layer j, ζ_{j,i} is a binary variable indicating whether the i^{th} rectified linear unit (ReLU) at layer j is active or not, [symbol] ⱼ and uⱼ denote the lower and upper bounds on the output values at layer j, c denotes the values of parameters of an output layer of the Q neural network, W and b are values for the parameters (i.e., weights and biases, respectively) of the remaining layers of the Q neural network, and B_{∞}(ā, Δ), bounded action space represented by a d-dimensional l_{∞}-ball with radius Δ and center ā, defines the initial action constraint. For example, the initial action constraints of a set of actions in an one-dimensional action space can be represented by the closed interval [ā−Δ, ā+Δ].

The initial action constraints, the binary variables, and the lower and upper bounds on the input values collectively define the set of action constraints that serve to constrain the variety of feasible solutions that may be derived as part of deriving the optimal value for the specified Q variable.

The system 100 then evaluates the MIP problem to identify an action that achieves the Q value objective qₓ*=max c^{T}z_{K} and meets the set of action constraints. The evaluation requires solving the MIP problem, which typically involves running a search algorithm based on linear programming relaxations, branch-and-bound, or both. In particular, the system 100 performs a systematic search on the action variables a of the input to the Q neural network and on the variables ζ indicating whether a ReLU is active or not, with the goal of determining which combination of action values provides an optimal solution for the Q value objective within the confines of the action constraints. In this way, the system 100 identifies an “argmax” action that has the highest Q value of any of the possible actions.

In response to any given observation, the system can also use the Q neural network 110 to determine a Q value for a given action, e.g., an action selected by the agent or another entity in response to receiving the observations. In particular, the system can fix the action input to the network by tightening the initial action constraints so that the bounded action space only consists of a single, known action. For example, the initial action constraints of a known action ā in an one-dimensional action space can be represented by a degenerate interval [ā, ā].

In mathematical terms, the system 100 processes a Q network input including (i) a current observation 106 which characterizes the given state of the environment and (ii) initial action constraint which specify the given action using the Q neural network 110 that includes K layers each having m units to output respective sets of output values at the different layers of the network:
z₁=(x, a), \hat{z}ⱼ=Wⱼ₋₁ zⱼ₋₁+bⱼ₋₁; zⱼ=h(\hat{z}ⱼ), j=2, . . . , K, Q_{θ}(x, a):=c^{T}\hat{z}_{K},
   where z₁ is the Q network input, h is the ReLU activation function, \hat{z}ⱼ denotes the pre-activation output values at layer j, zⱼ denotes the post-activation output values at layer j, θ denotes the Q network parameters, c denotes the values of parameters of an output layer of the Q neural network, W and b are values for the parameters (i.e., weights and biases, respectively) of the remaining layers of the Q neural network.

Accordingly, the system can determine the Q value for the given action by computing a product between (i) the parameter values of the output layer and (ii) the pre-activation output values at the output layer. Computing Q values in this way allows for the system 100 to rapidly predict expected returns resulting from the agent 102 performing different actions 156 in response to the observations 106. As will be described later, this is especially helpful during the training of neural network system 150.

The actor neural network 120 is configured to process the current observation 106 in accordance with current values of a plurality of network parameters (referred to as “actor network parameters”) and generate an actor network output specifying an estimated action that is an estimate of the argmax action 156 that would be identified by evaluating the MIP problem generated by the Q neural network 110 based on processing the current observation 106 and the initial action constraints. The actor neural network 120 can be, for example, a feed-forward network, a convolutional neural network, or a combination thereof with rectified linear unit (ReLU) activation. The actor network output may be one or more continuous values representing one or more corresponding actions to be performed. For example a magnitude of the action may be defined by the continuous value. An example of such a continuous value is a position, velocity or acceleration/torque applied to a robot joint or vehicle part. During training noise can be added to the output of the actor neural network 120 to facilitate action exploration.

In other words, in some implementations, the system 100 can use the actor neural network 120, e.g., in place of the Q neural network 110, to select actions to be performed by the agent. This can allow the system 100 to control the agent 102 with reduced latency and while consuming fewer computational resources than evaluating MIP problems formulated by the Q neural network 110.

The system then causes the agent to perform the action that has been selected using either the Q neural network 110 or actor neural network 120. For example, the system can do this by directly transmitting control signals to the agent or by transmitting data identifying a selected action 156 to a control system for the agent.

The training engine 130 is configured to train the Q neural network 110 and the actor neural network 120 to determine trained values of network parameters 158, i.e., the Q network parameters of the Q neural network 110 and the actor network parameters the actor neural network 120, by making use of a replay memory 140 which stores pieces of transitions generated as a consequence of the interaction of the agent 102 or another agent with the environment 104 or with another instance of the environment.

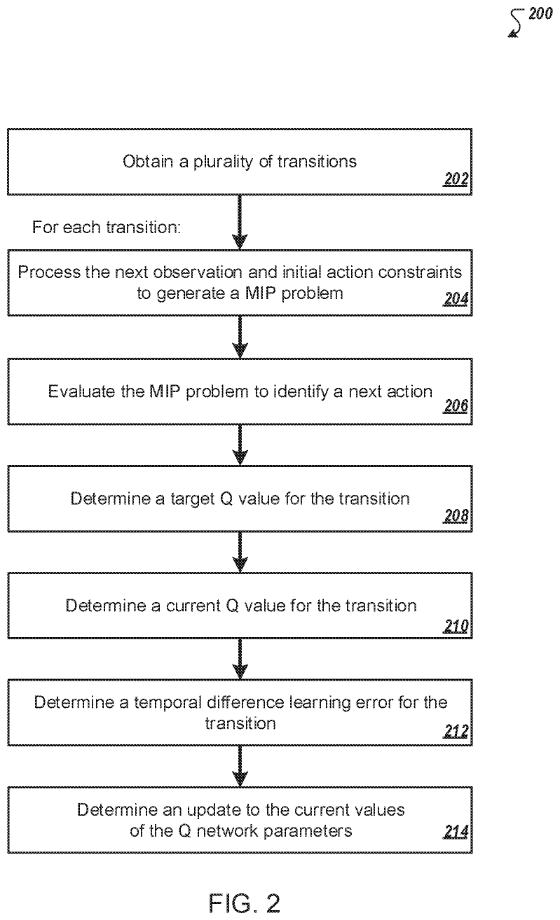

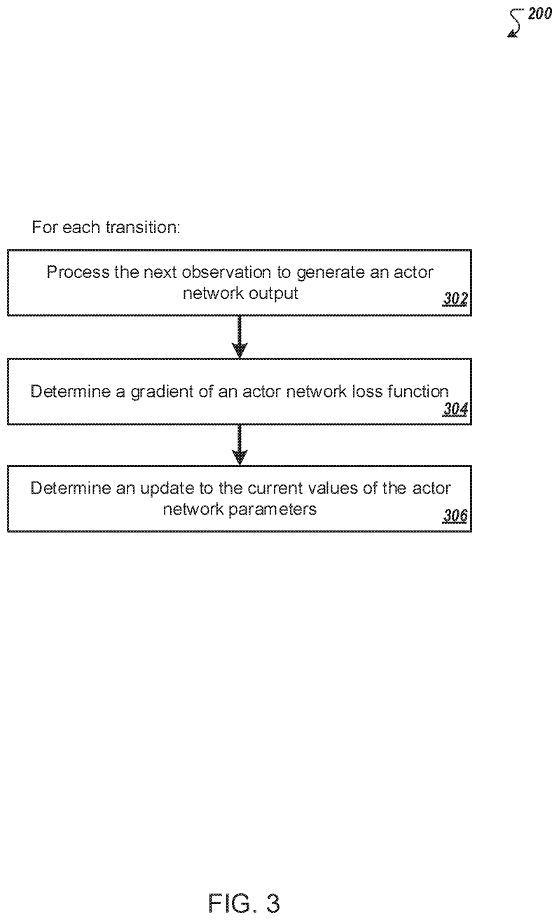

The training engine 130 trains the Q neural network 110 through reinforcement learning and, more specifically, Q learning. Additionally, the training engine 130 trains the actor neural network 120 through supervised learning training which can take place either during or after the RL training of the system. The training engine 130 can perform the supervised learning training using labeled task instances that are generated as a consequence of control of the agent by using the Q neural network 110. Training the neural networks 110 and 120 will be described in more detail below with reference to FIGS. 2 and 3.

FIG. 2 is a flow diagram of an example process 200 for controlling the agent. For convenience, the process 200 will be described as being performed by a system of one or more computers located in one or more locations. For example, a reinforcement learning system, e.g., the reinforcement learning system 100 of FIG. 1, appropriately programmed, can perform the process 200.

The system obtains a plurality of transitions (202) to be maintained at the replay memory. Each transition is typically generated as a result of the agent interacting with the environment. Each transition represents information about an interaction of the agent with the environment.

In some implementations, each transition is an experience tuple that includes: (i) a current observation characterizing a current state of the environment; (ii) a current action performed by the agent in response to the current observation; (iii) a reward received in response to the agent performing the current action; and (iv) a next observation characterizing a next state of the environment after the agent performs the current action, i.e., a state that the environment transitioned into as a result of the agent performing the current action.

The system can repeatedly perform the following steps 204-214 of the process 200 to train a Q neural network having a plurality of Q network parameters on each of one or more of the plurality of transitions. The Q neural network is formulated as a mixed integer programming (MIP). For each iteration, the system can select a transition either randomly or according to a prioritized strategy, e.g., based on the value of an associated temporal difference learning error or some other learning progress measure.

The system processes (i) the next observation and (ii) initial action constraints specifying a set of possible next actions to perform in response to the next observation using the Q neural network in accordance with current values of the Q network parameters to generate a MIP problem (204). The generation includes defining (i) a Q value objective function that specifies the Q value objective and that includes variables that can be adjusted to achieve the Q value objective based on the observation and (ii) a set of action constraints. The set of action constraints can be derived from the initial action constraints, respective sets of output values at one or more layers of the Q neural network, or both.

The system evaluates the MIP problem to identify a next action (206) that achieves the Q value objective and meets the set of action constraints. For example, the system can do this by providing as input the label values of the output, the set of action constraints, and Q value objective to a MIP solver, e.g., by using an application programming interface (API) offered by the MIP solver. The MIP solver implements software that is configured to solve the MIP problem by applying suitable optimization techniques, e.g., branch-and-bound or branch-and-cut algorithms. SCIP, CPLEX, and Gurobi are example of such MIP solvers.

The system then uses an optimal solution returned by the MIP solver to identify an argmax next action. The argmax next action is the action that, when provided as input to Q neural network in combination with the next observation, results in the Q neural network outputting a set of output values from which the highest Q value can be computed.

Due to its exhaustive (e.g., iterative or recursive) nature, however, deriving the optimal solution as part of this evaluation process may be far too slow in terms of wall clock time.

Thus, in some implementations, the system can use a dynamic tolerance technique to adjust stopping conditions for the MIP solver that is used to solve the MIP problem. The evaluation process is terminated once stopping conditions as defined by the tolerance parameters are met and a current solution (as of the termination) is returned. The system can assign, e.g., by using an API offered by the MIP solver, different values to the tolerance parameters depending on the actual training progress, thereby enabling solutions of various levels of optimality to be returned while consuming considerably less time, fewer computational resources (e.g., memory, computing power, or both), or both. For example, over the course of the RL training of the Q neural network, the system can accelerate respective MIP evaluation steps by dynamically adjusting the tolerance based on a temporal difference learning error or a number of training steps that have been performed.

In some implementations, at the commencement of step 206 the system can determine, e.g., based on the associated temporal difference learning error or other transitions in a same mini-batch of selected transitions, whether the next observation in the transition characterizes an inactive or less important next state and in response to a positive determination, refrain from evaluating the MIP problem by using the MIP solver that is computationally expensive to run. In these implementations, instead of performing steps 206-208, the system can efficiently determine an approximate Q value that is an estimate of the Q value for an argmax next action that would be identified using the solution to the MIP program. The system will resume to perform the process 200 at step 210. This allows the system to perform some training iterations more quickly, i.e., in terms of wall clock time.

For example, the system can use a dual filtering technique to determine, through convex relaxation, an upper-bound estimate of the Q value for an argmax next action that would be identified using the optimal solution to the MIP problem. As another example, the system can use a clustering technique to derive, from a next expected return computed for a first transition in the mini-batch and through first-order Taylor series expansion, approximate Q values for respective next actions in the remaining transitions in the mini-batch.

The system determines a temporal difference (TD) learning target for the transition (208) based on the next observation in the transition and the next action that has been identified using the solution to the MIP program. The TD learning target can be a sum of: (a) a time-discounted next expected return if the next action is performed in response to the next observation in the transition and (b) the reward in the transition.

The exact manner in which the system computes the next expected return is dependent on the reinforcement learning algorithm being used to train the Q neural network. For example, in a deep Q learning technique, the system provides as input (i) network observation and (ii) initial action constraints specifying the next action to the Q neural network, resulting in the Q neural network to output a set of output values from which the Q value for the next action can be computed and uses the Q value for the next action that is derived from the Q network outputs as the next expected return.

As another example, in a double deep Q learning technique, the system provides as input (i) network observation and (ii) initial action constraints specifying the next action to a target Q neural network, e.g., in place of the Q neural network, resulting in the target Q neural network to output a set of output values from which the Q value for the next action can be computed using the Q value for the next action that is derived from the target Q network outputs as the next expected return.

In this example, the system uses the target Q neural network to mimic the Q neural network in that, at intervals, parameter values from the Q neural network are copied across to the target Q neural network. The target Q neural network is used for determining the next expected returns which are then used for determining the TD learning targets from which drives the training of the Q neural network. This helps to stabilize the learning. In some implementations, rather than copying the parameter values to the target Q neural network, the parameter values of the target Q neural network slowly track the Q neural network (the “learning” neural network) according to θ′ →τθ+(1−τ) θ′ where θ′ denotes the parameter values of the target Q neural network and θ denotes the parameter values of the Q neural network and τ<<1.

The system determines a current Q value for the transition (210) using the Q neural network, i.e., by processing the current observation and initial action constraints specifying the current action in the transition using the Q neural network in accordance with current values of the Q network parameters to output a set of output values from which the current Q value for the transition can be computed. The current Q value is a current expected return as determined by the system if the current action in the transition is performed in response to the current observation in the transition.

The system determines a temporal difference learning error for the transition by computing a difference between the current Q value and the TD learning target (212).

The system uses the temporal difference learning error to determine an update to the current values of the Q network parameters (214). Specifically, the system can compute a gradient of temporal difference learning error with respect to the Q network parameters and determine, from the gradient, an update to the current values of the Q network parameters by using an appropriate gradient descent optimization methods, e.g., stochastic gradient descent, RMSprop or Adam. Alternatively, the system only proceeds to update the current parameter values once the steps 204-214 have been performed for an entire mini-batch of selected transitions. A mini-batch generally includes a fixed number of transitions, e.g., 16, 64, or 256. In other words, the system combines, e.g., by computing a weighted or unweighted average of, respective gradients that are determined during the fixed number of iterations of the steps 204-214 and proceeds to update the current Q network parameter values based on the combined gradient.

In general, the system can repeatedly perform the steps 204-210 until a termination criterion is reached, e.g., after the steps 204-214 have been performed a predetermined number of times or after a gradient of the temporal difference learning error has converged to a specified value.

The system trains the actor neural network through supervised learning. Although this can also take place after the RL training of the system, for convenience, the following description largely describes the supervised learning training of the actor neural network as being performed in conjunction with process 200 during which the system trains the Q neural network using RL training.

FIG. 3 is a flow diagram of an example process 300 for training an actor neural network. For convenience, the process 300 will be described as being performed by a system of one or more computers located in one or more locations. For example, a reinforcement learning system, e.g., the reinforcement learning system 100 of FIG. 1, appropriately programmed, can perform the process 300.

The system can repeatedly perform the process 300 to train the action neural network having a plurality of action network parameters on each of one or more of the plurality of transitions. Specifically, for each iteration, the system can perform the following steps based on the transitions that are selected from the process 200.

The system processes the next observation in the transition using the actor neural network and in accordance with current values of the actor network parameters to generate an actor network output (302). The actor network output specifies an estimated next action that is an estimate of the argmax next action identified based on evaluating the MIP problem formulated by the Q neural network. During training noise is added to the output to facilitate action exploration. For example, the noise can be Gaussian distributed noise with an exponentially decaying magnitude.

The system determines, e.g., through backpropagation, a gradient of an actor network loss function (304) with respect to the actor network parameters. In particular, the actor network loss function measures a difference between (i) a Q value for the estimated next action specified by the actor network output and (ii) a Q value for the argmax next action identified based on evaluating the MIP problem generated by the Q neural network.

As similarly described with reference to step 210 from the process 200, the system can use the Q neural network to determine the Q value for the estimated next action, i.e., by providing as input (i) network observation in the transition and (ii) initial action constraints specifying the estimated next action to the Q neural network, resulting in the Q neural network to output a set of output values from which the Q value for the estimated next action can be computed.

The system determines an update to the current values of the actor network parameters (306) based on the gradient of the actor network loss function and by using an appropriate gradient descent optimization methods, e.g., stochastic gradient descent, RMSprop or Adam.

After the system is trained, the system can proceed to use the neural network system to control the agent to perform a particular task.

In some implementations, the system specifically uses the actor neural network within the neural network system to control the agent. Because the actor neural network has been effectively trained to learn a mapping from each observation to an argmax action to be performed in response to the observation, the system can avoid repeatedly performing the computationally intensive MIP evaluation process. This can allow the system to control the agent with reduced latency and reduced consumption of computational resources while still maintaining effective performance.

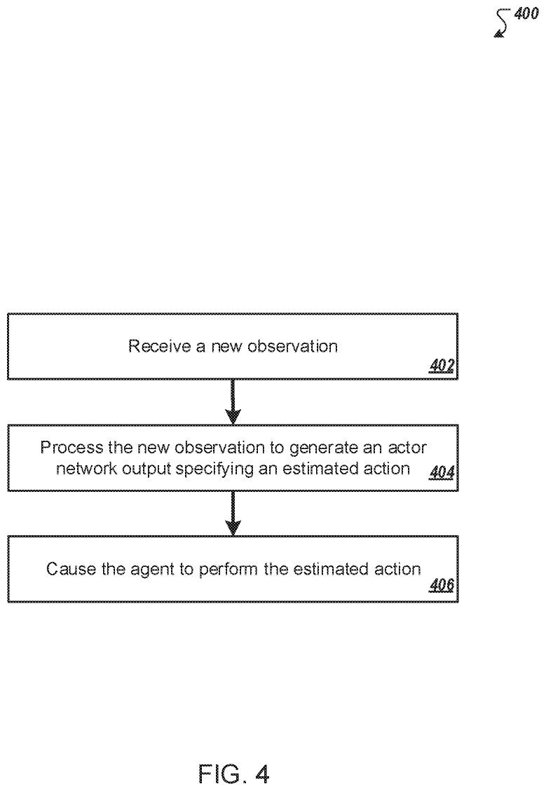

FIG. 4 is a flow diagram of an example process 400 for controlling the agent using an actor neural network. For convenience, the process 400 will be described as being performed by a system of one or more computers located in one or more locations. For example, a reinforcement learning system, e.g., the reinforcement learning system 100 of FIG. 1, appropriately programmed, can perform the process 400.

The system receives a new observation characterizing a new state of an environment (402) being interacted with by the agent. As described above, in some cases the observation can also include information derived from the previous time step, e.g., the previous action performed, the reward received at the previous time step, or both.

The system processes the new observation using the actor neural network to generate, i.e., in accordance with the trained values of the plurality of actor network parameters, an actor network output specifying an estimated action (404) that is an estimate of the action that would be identified by evaluating the MIP problem generated by the Q neural network based on processing the new observation and initial action constraints. For example, the actor network output may be one or more continuous values representing one or more corresponding actions to be performed by the agent.

The system causes the agent to perform the estimated action (406), i.e., by instructing the agent to perform the action or passing a control signal to a control system for the agent.

In some other implementations, the system can use the Q neural network to control the agent. The MIP formulation of Q neural network ensures that an argmax action at each state of the environment can generally be identified, and thereby allows the system to control the agent in a way that expected long-term return to be received by the agent is maximized.

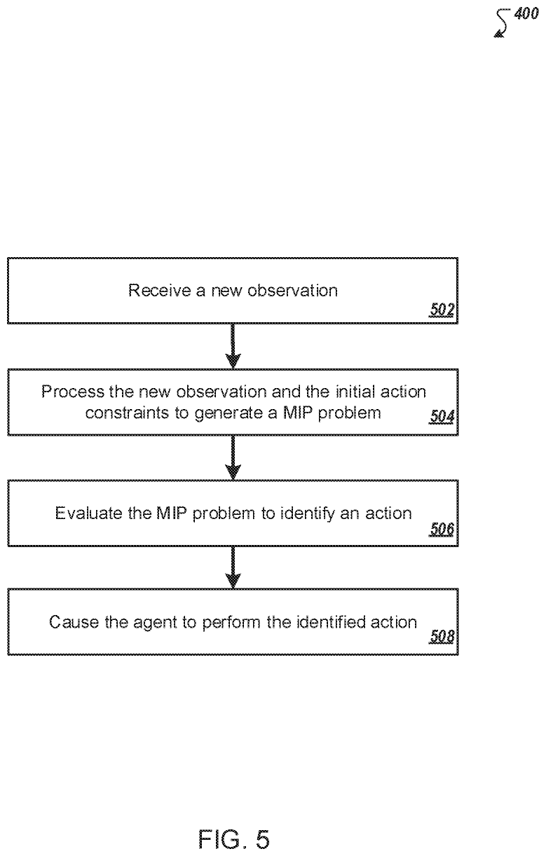

FIG. 5 is a flow diagram of an example process 500 for controlling an agent using a Q neural network. For convenience, the process 500 will be described as being performed by a system of one or more computers located in one or more locations. For example, a reinforcement learning system, e.g., the reinforcement learning system 100 of FIG. 1, appropriately programmed, can perform the process 500.

The system receives the new observation characterizing the new state of the environment (502).

The system processes the new observation and the initial action constraints using the Q neural network to generate a MIP problem (504) in accordance with the trained values of the plurality of Q network parameters. The generation includes defining (i) a Q value objective function that specifies the Q value objective and that includes variables that can be adjusted to achieve the Q value objective based on the new observation and (ii) a set of action constraints. The set of action constraints can be derived from the initial action constraints, respective sets of output values at one or more layers of the Q neural network, or both.

The system evaluates the MIP problem to identify an action that achieves the Q value objective and meets the initial action constraints (506), e.g., by using a MIP solver.

The system causes the agent to perform the identified action (508), i.e., by instructing the agent to perform the action or passing a control signal to a control system for the agent.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow, PyTorch, Caffe2, JAX, or Theano framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining a plurality of transitions that are each generated as a result of an agent interacting with an environment, each transition comprising:
a current observation characterizing a current state of the environment,
a current action performed by the agent in response to the current observation,
a reward received in response to the agent performing the current action, and
a next observation characterizing a next state of the environment;
training a Q neural network having a plurality of Q network parameters on the transitions, wherein the Q neural network is configured to process an observation and initial action constraints in accordance with the Q network parameters to generate a mixed-integer programming (MIP) problem based on a Q value objective and the initial action constraints, the initial action constraints specifying a set of possible actions that can be performed by the agent to interact with the environment,
the training comprising, for each of one or more of the plurality of transitions:
processing the next observation and initial action constraints specifying a set of possible next actions to perform in response to the next observation using the Q neural network in accordance with current values of the Q network parameters to generate the mixed-integer programming (MIP) problem including defining a Q value objective function and a set of action constraints;
evaluating the MIP problem to identify a next action that achieves the Q value objective and meets the set of action constraints;
determining, based on the next observation and the next action, a temporal difference learning target for the transition;
determining, based on processing the current observation and initial action constraints specifying the current action using the Q neural network in accordance with current values of the Q network parameters, a current Q value for the transition;
determining a temporal difference learning error for the transition by computing a difference between the current Q value and the temporal difference learning target; and
using the temporal difference learning error in determining an update to the current values of the Q network parameters.

2. The method of claim 1, wherein generate the mixed-integer programming (MIP) problem including defining the Q value objective function and the set of action constraints comprises:
generating the Q value objective function that specifies the Q value objective and that includes variables that can be adjusted to achieve the objective based on the observation and the set of action constraints, wherein the variables include a plurality of outputs at an output layer of the Q neural network.

3. The method of claim 2, wherein generate the mixed-integer programming (MIP) problem including defining the Q value objective function and the set of action constraints further comprises:
generating the set of action constraints based on a respective plurality of outputs at one or more piece-wise linear activation layers of the Q neural network.

4. The method of claim 1, wherein evaluating the MIP problem to identify an action that achieves the Q value objective and meets the initial action constraints comprises:
adjusting, using a dynamic tolerance technique, stopping conditions for a MIP solver that is used to evaluate the MIP problem.

5. The method of claim 1, wherein determining the temporal difference learning target comprises:
determining, using a dual filtering technique or a clustering technique, an approximate temporal difference learning target that is an estimate of the temporal difference learning target for the transition.

6. The method of claim 1, further comprising training an actor neural network having a plurality of actor network parameters on the transitions, the training comprising, for each of the one or more of the plurality of transitions:
processing the next observation using the actor neural network in accordance with current values of the actor network parameters to generate an actor network output specifying an estimated next action that is an estimate of the next action identified based on evaluating the MIP problem generated by the Q neural network;
determining a gradient of an actor network loss function with respect to the actor network parameters, wherein the actor network loss function measures a difference between (i) a Q value for the estimated next action specified by the actor network output and (ii) a Q value for the next action identified based on evaluating the MIP problem generated by the Q neural network; and
determining, based on the gradient of the actor network loss function, an update to the current values of the actor network parameters.

7. The method of claim 6, wherein the Q value for the estimated next action specified by the actor network output is generated based on processing the next observation and initial action constraints specifying the estimated next action using the Q neural network in accordance with current values of the Q network parameters.

8. The method of claim 6, further comprising:
receiving a new observation characterizing a new state of the environment being interacted with by the agent;
processing the new observation using the actor neural network having the plurality of actor network parameters to generate an actor network output specifying an estimated action that is an estimate of the action that would be identified by evaluating the MIP problem generated by the Q neural network based on processing the new observation and initial action constraints; and
causing the agent to perform the estimated action.

9. The method of claim 8, wherein generating the actor network output specifying the estimated action comprises:
adding exploration noise to the actor network output.

10. The method of claim 1, wherein the possible set of actions is a continuous set of actions.

11. The method of claim 1, further comprising:
receiving the new observation characterizing the new state of the environment being interacted with by the agent;
processing the new observation and the initial action constraints using the Q neural network to generate the mixed-integer programming (MIP) problem including defining a Q value objective function and a set of action constraints;
evaluating the MIP problem to identify an action that achieves the Q value objective and meets the set of action constraints; and
causing the agent to perform the identified action.

12. A system comprising one or more computers and one or more storage devices storing instructions that when executed by one or more computers cause the one or more computers to perform operations comprising:
obtaining a plurality of transitions that are each generated as a result of an agent interacting with an environment, each transition comprising:
a current observation characterizing a current state of the environment,
a current action performed by the agent in response to the current observation,
a reward received in response to the agent performing the current action, and
a next observation characterizing a next state of the environment;
training a Q neural network having a plurality of Q network parameters on the transitions, wherein the Q neural network is configured to process an observation and initial action constraints in accordance with the Q network parameters to generate a mixed-integer programming (MIP) problem based on a Q value objective and the initial action constraints, the initial action constraints specifying a set of possible actions that can be performed by the agent to interact with the environment,
the training comprising, for each of one or more of the plurality of transitions:
processing the next observation and initial action constraints specifying a set of possible next actions to perform in response to the next observation using the Q neural network in accordance with current values of the Q network parameters to generate the mixed-integer programming (MIP) problem including defining a Q value objective function and a set of action constraints;
evaluating the MIP problem to identify a next action that achieves the Q value objective and meets the set of action constraints;
determining, based on the next observation and the next action, a temporal difference learning target for the transition;
determining, based on processing the current observation and initial action constraints specifying the current action using the Q neural network in accordance with current values of the Q network parameters, a current Q value for the transition;
determining a temporal difference learning error for the transition by computing a difference between the current Q value and the temporal difference learning target; and
using the temporal difference learning error in determining an update to the current values of the Q network parameters.

13. The system of claim 12, wherein generate the mixed-integer programming (MIP) problem including defining the Q value objective function and the set of action constraints comprises:
generating the Q value objective function that specifies the Q value objective and that includes variables that can be adjusted to achieve the objective based on the observation and the set of action constraints, wherein the variables include a plurality of outputs at an output layer of the Q neural network.

14. The system of claim 13, wherein generate the mixed-integer programming (MIP) problem including defining the Q value objective function and the set of action constraints further comprises:
generating the set of action constraints based on a respective plurality of outputs at one or more piece-wise linear activation layers of the Q neural network.

15. The system of claim 12, wherein the operations further comprise training an actor neural network having a plurality of actor network parameters on the transitions, the training comprising, for each of the one or more of the plurality of transitions:
processing the next observation using the actor neural network in accordance with current values of the actor network parameters to generate an actor network output specifying an estimated next action that is an estimate of the next action identified based on evaluating the MIP problem generated by the Q neural network;
determining a gradient of an actor network loss function with respect to the actor network parameters, wherein the actor network loss function measures a difference between (i) a Q value for the estimated next action specified by the actor network output and (ii) a Q value for the next action identified based on evaluating the MIP problem generated by the Q neural network; and
determining, based on the gradient of the actor network loss function, an update to the current values of the actor network parameters.

16. The system of claim 15, wherein the Q value for the estimated next action specified by the actor network output is generated based on processing the next observation and initial action constraints specifying the estimated next action using the Q neural network in accordance with current values of the Q network parameters.

17. The system of claim 15, wherein the operations further comprise:
receiving a new observation characterizing a new state of the environment being interacted with by the agent;
processing the new observation using the actor neural network having the plurality of actor network parameters to generate an actor network output specifying an estimated action that is an estimate of the action that would be identified by evaluating the MIP problem generated by the Q neural network based on processing the new observation and initial action constraints; and
causing the agent to perform the estimated action.

18. The system of claim 12, wherein the operations further comprise:
receiving the new observation characterizing the new state of the environment being interacted with by the agent;
processing the new observation and the initial action constraints using the Q neural network to generate the mixed-integer programming (MIP) problem including defining a Q value objective function and a set of action constraints;
evaluating the MIP problem to identify an action that achieves the Q value objective and meets the set of action constraints; and
causing the agent to perform the identified action.

19. One or more computer-readable storage media storing instructions that when executed by one or more computers cause the one or more computers to perform operations comprising:
obtaining a plurality of transitions that are each generated as a result of an agent interacting with an environment, each transition comprising:
a current observation characterizing a current state of the environment,
a current action performed by the agent in response to the current observation,
a reward received in response to the agent performing the current action, and
a next observation characterizing a next state of the environment;
training a Q neural network having a plurality of Q network parameters on the transitions, wherein the Q neural network is configured to process an observation and initial action constraints in accordance with the Q network parameters to generate a mixed-integer programming (MIP) problem based on a Q value objective and the initial action constraints, the initial action constraints specifying a set of possible actions that can be performed by the agent to interact with the environment,
the training comprising, for each of one or more of the plurality of transitions:
processing the next observation and initial action constraints specifying a set of possible next actions to perform in response to the next observation using the Q neural network in accordance with current values of the Q network parameters to generate the mixed-integer programming (MIP) problem including defining a Q value objective function and a set of action constraints;
evaluating the MIP problem to identify a next action that achieves the Q value objective and meets the set of action constraints;
determining, based on the next observation and the next action, a temporal difference learning target for the transition;
determining, based on processing the current observation and initial action constraints specifying the current action using the Q neural network in accordance with current values of the Q network parameters, a current Q value for the transition;
determining a temporal difference learning error for the transition by computing a difference between the current Q value and the temporal difference learning target; and
using the temporal difference learning error in determining an update to the current values of the Q network parameters.

20. The computer-readable storage media of claim 19, wherein the operations further comprise training an actor neural network having a plurality of actor network parameters on the transitions, the training comprising, for each of the one or more of the plurality of transitions:
processing the next observation using the actor neural network in accordance with current values of the actor network parameters to generate an actor network output specifying an estimated next action that is an estimate of the next action identified based on evaluating the MIP problem generated by the Q neural network;
determining a gradient of an actor network loss function with respect to the actor network parameters, wherein the actor network loss function measures a difference between (i) a Q value for the estimated next action specified by the actor network output and (ii) a Q value for the next action identified based on evaluating the MIP problem generated by the Q neural network; and
determining, based on the gradient of the actor network loss function, an update to the current values of the actor network parameters.
